(19) United States
(12) Patent Application Publication
(10) Pub. No.: US 2025/0123152 A1
(43) Pub. Date: Apr. 17, 2025

(54) SYSTEMS OR DEVICES AND METHODS FOR MANAGING THERMOCOUPLE SERVICE LIFE

(71) Applicants: BASF CORPORATION, Florham Park, NJ (US); OWENS- BROCKWAY GLASS CONTAINER INC., Perrysburg, OH (US)

(72) Inventors: Nathan YOUEL, Portland, OR (US); John Justin GROSSI, Fremont, CA (US); Ahmad WASSEL, Perrysburg, OH (US)

(21) Appl. No.: 18/695,226

(22) PCT Filed: Sep. 26, 2022
(86) PCT No.: PCT/US2022/076995

§ 371 Date: Mar. 25, 2024

Related U.S. Application Data
(60) Provisional application No. 63/261,683, filed on Sep. 27, 2021.

(51) Int. Cl. G01K 7/02

(52) U.S. Cl. CPC G01K 7/025; G01K 7/021

(57) ABSTRACT

The present disclosure is directed to a thermocouple management device for monitoring a preset service life of at least one thermocouple and methods of use. The device may include: a housing; at least one terminal disposed on the housing configured to receive, from at least one thermocouple, a temperature measurement of a material; at least one interface component disposed on the housing configured to receive and adjust a time period associated with the preset service life of the at least one thermocouple; at least one indicator disposed on the housing; and a timing component disposed within the housing, wherein the timing component is configured to: instantiate a timer upon installation of the at least one thermocouple; and upon expiration of the timer, trip at least one relay to disable the at least one thermocouple.

This application claims priority to U.S. Provisional Application No. 63/261,683, filed Sep. 27, 2022; the contents of which is incorporated herein by reference in its entirety.

The present disclosure relates to systems or devices, methods, and computer-readable media for the management of thermocouples. In particular, the present disclosure generally relates to inventive and unconventional systems or devices configured for monitoring the service life of thermocouples during use.

Thermocouples are electrical devices that are used across a wide range of applications as temperature sensors. A thermocouple includes dissimilar electrical conductors that form an electrical junction. When this junction is heated or cooled, it creates a measurable voltage via the Seebeck effect, or the electromotive force generated between two points of electrically conducting material due to the temperature difference between them. This measurable voltage can be converted to temperature value, thus providing an effective means for temperature measurement. Thermocouples are used across a wide range of applications in science and industry. For example, thermocouples are used to measure temperatures in the steel industry, gas turbines, engines, manufacturing, power production, process plants, and other industrial processes. Additionally, thermocouples are used in homes and businesses as temperature sensors in thermostats and as flame sensors in safety devices for gas-powered appliances.

There are many different types of thermocouples, generally categorized by the combination of alloys used to form the electrical junction. For example, some types include nickel-alloy thermocouples, platinum/rhodium-alloy thermocouples, and tungsten/rhenium-alloy thermocouples. Different types are best suited for different applications, based on factors such as cost, availability, convenience, melting point, chemical properties, stability, and output. These different types of thermocouples may each be associated with multiple sub-types, or calibrations. For example, platinum/rhodium-alloy thermocouples may have a type S, R, or B calibration, and are generally only used for high-temperature measurements (e.g., 1800 degrees Celsius) due to their high cost and low sensitivity.

The practical lifetime of thermocouples may be limited by thermocouple aging. The thermoelectric coefficients of the wires in a thermocouple that is used to measure very high temperatures may change with time, and the measurement voltage accordingly drops. As thermocouples age in a process, their conductors can lose homogeneity due to chemical and metallurgical changes caused by extreme or prolonged exposure to high temperatures. Using a thermocouple past its practical lifetime can sometimes cause catastrophic failure of the thermocouple, resulting in the destruction of its components and materials.

Conventionally, thermocouples are often used until failure, disposed of, and replaced. However, allowing catastrophic failure in thermocouples can result in the destruction of extremely valuable materials, such as platinum and rhodium, that could other be recovered and reused or repurposed. Accordingly, there is a need for systems or devices and methods for monitoring the practical lifetime of thermocouples to prevent catastrophic failure.

In one aspect of the present disclosure, it is directed to a thermocouple management device for monitoring a preset service life of at least one thermocouple. The device may include: a housing; at least one terminal disposed on the housing configured to receive, from at least one thermocouple, a temperature measurement of a material; at least one interface component disposed on the housing configured to receive and adjust a time period associated with the preset service life of the at least one thermocouple; at least one indicator disposed on the housing; and a timing component disposed within the housing, wherein the timing component is configured to: instantiate a timer upon installation of the at least one thermocouple, wherein the timer expires at the end of the time period; and upon expiration of the timer, trip at least one relay to disable the at least one thermocouple and to cause the at least one indicator to display an indication of the end of the service life of the at least one thermocouple.

Another aspect of the present disclosure is directed to a method for monitoring a preset service life of thermocouples. The method may include: installing at least one thermocouple by: configuring the at least one thermocouple to monitor the temperature of a material; and coupling the at least one thermocouple to a service life monitoring device; initializing the device with a time period associated with at least one thermocouple to be installed, wherein the time period is adjustable; instantiating a timer upon installation of the at least one thermocouple, wherein the timer expires at the end of the time period; and upon expiration of the timer: tripping at least one relay to disable the at least one thermocouple and to cause at least one indicator on the device to display an indication of the end of the service life of the at least one thermocouple.

Other systems, methods, and computer-readable media are also discussed herein.

### BRIEF DESCRIPTION OF THE DRAWINGS

FIG. 1A illustrates a front view of an exemplary thermocouple management device for monitoring a service life of at least one thermocouple.

FIG. 1B illustrates a side view of an exemplary thermocouple management device for monitoring a service life of at least one thermocouple.

FIG. 1C illustrates a front internal view of an exemplary thermocouple management device for monitoring a service life of at least one thermocouple.

FIG. 2 is a flow chart illustrating an exemplary thermocouple management process for monitoring a service life of at least one thermocouple.

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

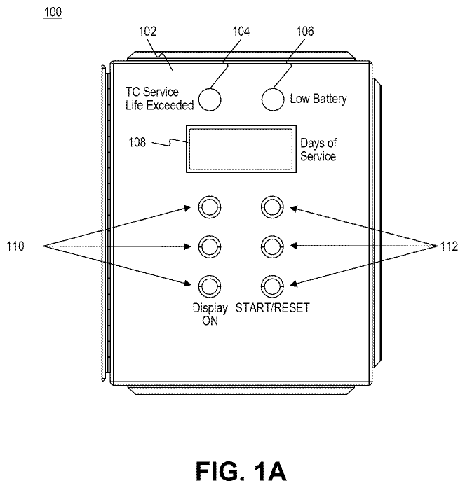

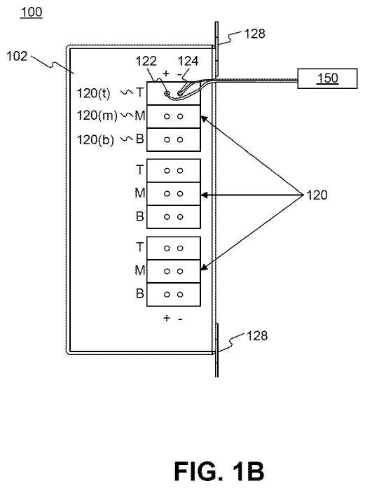

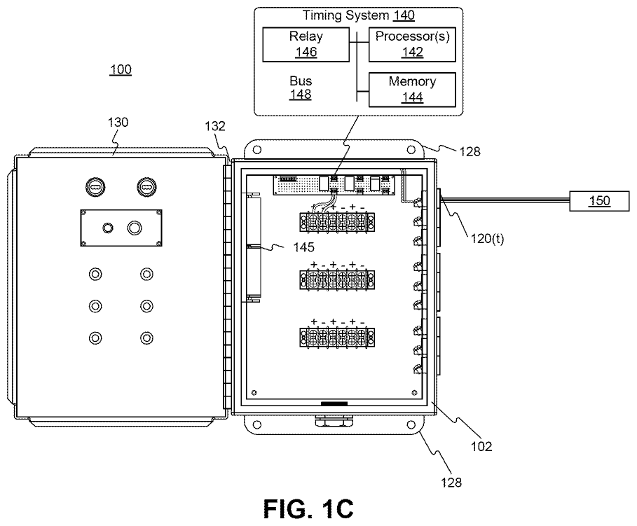

FIG. 1A illustrates a front view of an exemplary thermocouple management device 100 for monitoring a service life of at least one thermocouple. In some embodiments, device 100 may include housing 102. Housing 102 may be constructed of any suitable material and may be capable of retaining one or more components of the disclosed embodiments. Device 100 may include several different indicators disposed on housing 102, such as service life exceeded indicator 104, low battery indicator 106, and days of service indicator 108. Device 100 may also include one or more interface components, such as display buttons 110 or timer start/reset buttons 112. Although only buttons are illustrated, it is to be understood that other types of interface components, such as dials, switches, keypads, keyboards, touchscreens, or any other interface component that may be configured to control the indicators or to receive, adjust, and/or reset a time period, and any appropriate number of interface components may be used. The time period, for example, may be associated with a preset or practical service life of the at least one thermocouple to be coupled to the device. Additionally, or alternatively, the time period may be associated with a design life (e.g., an expected time of life before catastrophic failure occurs), an allowable drift level (e.g., allowable tolerances of thermocouple drift before operational performance is required), or a preventative maintenance schedule (e.g., a suggested time at which maintenance should be performed to prevent or reduce the risk of a future failure).

FIG. 1B illustrates a side view of an exemplary monitoring device 100 for managing a service life of at least one thermocouple. As illustrated, housing 102 may be coupled to mounts 128 that may be used to fix the device to a floor, wall, ceiling, or any other suitable surface. In some embodiments, at least one terminal 120 is disposed on the housing configured to receive, from at least one thermocouple, a temperature measurement of a material. For example, this is achieved by placing positive and negative ends of the thermocouple wires in the corresponding socket on the terminal. The positive end 122 and negative end 124 associated with thermocouple 150 may be placed in their corresponding socket in top terminal 120(t).

Although FIG. 1B only illustrates wires from thermocouple 150 connecting to top terminal 120(t), device 100 may be configured to accommodate thermocouples with additional sets of wires. For example, device 100 may be configured to be coupled with one or more single level thermocouples (e.g., thermocouple 150), bi-level thermocouples, or tri-level thermocouples. A bi-level thermocouple may have two sets of wires with positive and negative ends that can be plugged into top terminal 120(t) and bottom terminal 120(b), whereas a tri-level thermocouple may have three sets of wires with positive and negative ends that can be plugged into each of top terminal 120(t), middle terminal 120(m), and bottom terminal 120(b). As shown in FIG. 1B, device 100 can accommodate up to three tri-level thermocouples because it includes three tri-level panel jacks. However, it is to be understood that device 100 can include any number of any type of panel jacks, such as three bi-level jacks, two bi-level jacks, or any other conceivable combination of panel jacks.

In some embodiments, terminals 120 may be configured to receive signals associated with a plurality of thermocouples or thermocouple calibrations. For example, terminals 120 may be configured to receive signals associated with one or more of a type S, R, or B calibration for platinum/rhodium-alloy thermocouples, although terminals may also be configured to receive signals associated with calibrations for other types of thermocouples as well, such as nickel-alloy thermocouples (E, J, K, M, N, and T calibrations) or tungsten/rhenium-alloy thermocouples (C, D, and G calibrations), among other types of thermocouples.

In some embodiments, FIG. 1C illustrates a front view of exemplary thermocouple management device 100 for monitoring a service life of at least one thermocouple in an open position. That is, door 130 has been moved to an open position by way of hinges 132 in order to allow access to the interior of housing 102 of device 100. However, those skilled in the art will understand that the interior of housing 102 may be accessed through other means, and that housing 102 does not necessarily include a door 130 or hinges 132. In some embodiments, door 130 may include one or more fixtures (not shown) such as clamps, latches, or any other mechanical fasteners configured to fix door 130 in a closed position and/or release door 130 into an open position. Although door 130 is illustrated as opening from the left side of the front panel of device 100, it is to be understood that door 130 can be configured to open from the left, right, top, or bottom of any panel of device 100.

In some embodiments, device 100 may include a timing component (e.g., timing system 140) and batteries 145 (if battery powered) disposed within the interior of housing 102. However, instead of batteries, device 100 may be powered by alternative means, for example through alternating-current or direct-current power sources. Timing system 140 may include one or more processors 142 and memories 144 operatively coupled by a bus 148. Processor 142 may include one or more processors (e.g., microprocessors) programmed to perform methods consistent with this disclosure and associated hardware, software, and/or hardwired logic circuitry. The processors may operate singly or in parallel. Memory 144 may include non-transitory computer-readable media, e.g., both read-only memory (ROM) and random-access memory (RAM). At various times, computer-readable instructions, data structures, program modules, and data necessary for execution of the methods disclosed herein may be stored in ROM and/or RAM portions of memory 144. In particular, memory 144 may store an operating system, one or more client-side application programs (e.g., computer or mobile applications programs) and/or program modules, and program data. Bus 148 may include a memory bus or memory controller, a peripheral bus, and a local bus, each implemented using any of a variety of bus architectures.

In some embodiments, the timing component (e.g., timing system 140) allows for the input of a time period. In some embodiments, the time period is hours, days, weeks, months, and/or years. For example, the time period ranges from 24 hours to 2 years. In other embodiments, the time period ranges from one to seven years.

Consistent with some embodiments of the present disclosure, timing system 140 may include one or more relays 146. Relay(s) 146 may be configured to trip, for example, in response to the expiration of a time instantiated by timing system 140. For example, memory 144 may store instructions which, when executed by processors 142, instantiate a timer configured to expire at a time associated with the service life of thermocouple 150. Once the timer expires, processor(s) 142 may cause relay 146 to trip. As a result of relay 146 being tripped, the circuit including thermocouple 150 is disrupted, thereby disabling the thermocouple. In some embodiments, the at least one indicator may display an indication of the end of the service life of the at least one thermocouple upon the expiration of the time. For example, service life exceeded indicator 104 may be configured to display an indication of the end of the service life of thermocouple 150 when the circuit is disrupted (e.g., from the tripped relay) or when the timer expires. It is to be understood that the potential arrangements of the interior components of device 100 are not limited to the configurations provided. For example, timing system 140 and/or batteries 145 may be disposed on an interior of door 130 rather than an interior of the housing 102, consistent with the present disclosure.

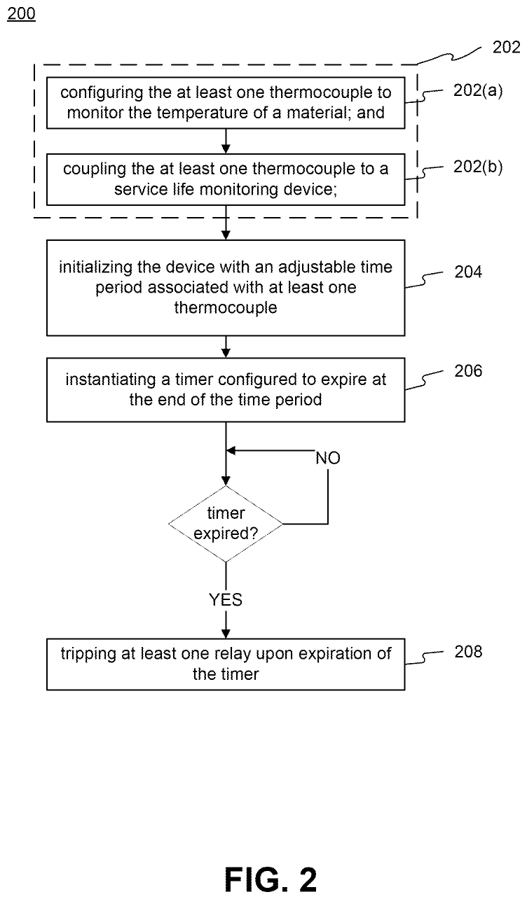

FIG. 2 is a flow chart illustrating an exemplary thermocouple management process 200 for monitoring a service life of at least one thermocouple. One or more steps of process 200 may be implemented by executing computer-readable instructions, data structures, and/or program modules stored in memories 144.

In step 202, at least one thermocouple is installed through sub-steps 202(a) and sub-step 202(b). In sub-step 202(a), the at least one thermocouple (e.g., thermocouple 150) is configured to monitor the temperature of a material. For example, thermocouple 150 may be positioned near a material such that the material heats/cools the electrical junction between two dissimilar conducting metals of thermocouple 150. At sub-step 202(b), the at least one thermocouple (e.g., thermocouple 150) is coupled to a service life monitoring device (e.g., thermocouple management device 100). For example, the positive wire 122 and negative wire 124 may be plugged into terminal 120(t) of device 100, thereby creating a circuit including thermocouple 150 and the circuitry of device 100.

In step 204, the device (e.g., thermocouple management device 100) is initialized with an adjustable time period associated with the at least one thermocouple (e.g., thermocouple 125). For example, the time period may be input by a user using one or more interface components of the device, and the time period may then be stored in a memory of the device (e.g., memory 144).

In step 206, a timer is instantiated (e.g., by timing system) upon installation of the at least one thermocouple, the timer being configured to expire at the end of the time period initialized in step 204. For example, memory 144 may store instructions that, when executed by processor(s) 142, cause timing system 140 to start a timer set to expire at a preset service life of thermocouple 150 when thermocouple 150 is installed according to step 202.

In some embodiments, after step 206, process 200 stops and does not proceed until the timer instantiated at step 206 expires. Once the timer expires, however, process 200 proceeds to step 208. At step 208, the timing device trips at least one relay (e.g., relay 145) in response to the expiration of the timer. For example, timing system 140 may maintain a timer that instantiated when thermocouple 150 was installed. Upon expiration of the timer, timing system 140 trips relay 146, thereby disabling thermocouple 150 and causing service life exceeded indicator 104 to display an indication that the service life of thermocouple 150 has expired. At this time, there is imminent risk of catastrophic failure of the thermocouple if it is not removed and replaced immediately. In some embodiments, the disabled thermocouple may also no longer output a temperature measurement due to relay 146 being tripped, an a control system associated with the device may trigger an alarm that there is an open junction until a new thermocouple is installed and the timer is started again.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A thermocouple management device for monitoring a preset service life of at least one thermocouple, comprising:
a housing;
at least one terminal disposed on the housing configured to receive, from the at least one thermocouple, a temperature measurement of a material;
at least one interface component disposed on the housing configured to receive and adjust a time period associated with the preset service life of the at least one thermocouple;
at least one indicator disposed on the housing; and
a timing component disposed within the housing, wherein the timing component is configured to:
instantiate a timer upon installation of the at least one thermocouple, wherein the timer expires at the end of the time period; and
upon expiration of the timer, trip at least one relay to disable the at least one thermocouple and to cause the at least one indicator to display an indication of the end of the service life of the at least one thermocouple.

2. The device of claim 1, wherein the time period is associated with a design life, an allowable drift level, or a preventative maintenance schedule.

3. The device of claim 1 wherein the at least one terminal includes at least one of a three tri-level, a three bi-level, or a two bi-level panel jack.

4. The device of claim 1 wherein the at least one thermocouple comprises at least one of a single level thermocouple, a bi-level thermocouple, or a tri-level thermocouple.

5. The device of claim 1, wherein the at least one interface component is further configured to reset the timer.

6. The device of claim 1, wherein the at least one indicator comprises a display component configured to display the service life of the at least one thermocouple based on the timer.

7. The device of claim 6, wherein the service life is displayed as days left in service or days of service.

8. The device of claim 1, wherein the device is battery-powered, and the at least one indicator includes a battery life indicator.

9. The device of claim 1, wherein the device is powered via alternating-current or direct-current power.

10. The device of claim 1, wherein the at least one terminal is configured to receive signals associated with a plurality of thermocouple calibrations.

11. The device of claim 1, wherein the timing component comprises at least non-transitory computer-readable medium containing instructions that, when executed by at least one processor, controls the timer.

12. A thermocouple management method for monitoring a preset service life of thermocouples, comprising:
installing at least one thermocouple by:
configuring the at least one thermocouple to monitor the temperature of a material; and
coupling the at least one thermocouple to a service life monitoring device;
initializing the device with a time period associated with at least one thermocouple to be installed, wherein the time period is adjustable;
instantiating a timer upon installation of the at least one thermocouple, wherein the timer expires at the end of the time period; and
upon expiration of the timer:
tripping at least one relay to disable the at least one thermocouple and to cause at least one indicator on the device to display an indication of the end of the service life of the at least one thermocouple.

13. The method of claim 12, wherein the time period is associated with a design life, an allowable drift level, or a preventative maintenance schedule.

14. The method of claim 12, wherein coupling the at least one thermocouple to the device comprises coupling the at least one thermocouple to at least one of a three tri-level, a three bi-level, or a two bi-level panel jack disposed on the device.

15. The method of claim 12, wherein the at least one thermocouple comprises at least one of a single level thermocouple, a bi-level thermocouple, or a tri-level thermocouple.

16. The method of claim 12, further comprising resetting the timer.

17. The method of claim 12, wherein:
the at least one indicator comprises a display component; and
causing the at least one indicator on the device to display the indication comprises displaying, on the display component, the service life of the at least one thermocouple based on the timer.

18. The method of claim 17, wherein displaying the service life comprises displaying days left in service or days of service.

19. The method of claim 12, further comprising displaying a battery-life on the at least one indicator.

20. The method of claim 12, further comprising powering the device via alternating-current or direct-current power.

21. The method of claim 12, wherein coupling the at least one thermocouple to the device comprises configuring the device to receive signals associated with a plurality of thermocouples.

22. The method of claim 12, wherein coupling the at least one thermocouple to the device comprises configuring the device to receive signals associated with a plurality of thermocouple calibrations.
